(19) United States
(12) Patent Application Publication
(10) Pub. No.: US 2012/0252490 A1
(43) Pub. Date: Oct. 4, 2012

(54) Location Discovery

(76) Inventors: Brian Hernacki, San Carlos, CA (US); Vitall Lovich, (US)

(21) Appl. No.: 13/079,087

(22) Filed: Apr. 4, 2011

(51) Int. Cl. H04W 24/00

(52) U.S. Cl. 455/456.2

(57) ABSTRACT

Embodiments provide methods, apparatuses, and articles of manufacture generating geographic location data and contextual location data in response to a location discovery event. The geographic location data and the contextual location data may be transmitted to a network accessible server.

### BACKGROUND

Computing devices are continually developing. Some of these developments further their mobility, enabling users to remain connected to various networks in various locations. This mobility, however, creates opportunities for the computing devices to be lost or stolen.

### BRIEF DESCRIPTION OF THE DRAWINGS

FIG. 1 illustrates a block diagram of an apparatus in accordance with an embodiment;

FIG. 2 illustrates a block diagram of an apparatus in accordance with an embodiment;

FIG. 3 illustrates a block diagram of an apparatus in accordance with an embodiment;

FIG. 4 illustrates a diagram of a system in accordance with an embodiment;

FIG. 5 illustrates a location eport in accordance with an embodiment; and

FIGS. 6-9 illustrate flow diagrams in accordance h various embodiments.

### DETAILED DESCRIPTION

Computing devices have become common within modern society. As their associated technology develops, these devices are becoming more mobile and autonomous. For example, as batteries become smaller and longer lasting, the mobility of their corresponding devices increases. This mobility and autonomy increase an opportunity for the computing device to be misplaced, lost, or stolen.

In the present disclosure, methods, apparatuses, systems, and articles of manufacture are disclosed that enable a computing device to report geographic location data and contextual location data to a storage device. The geographic and contextual location data may be reported in response to various events including a low battery indication, a worsening network indication, and/or receipt of a wipe or reset command. In this manner, a location of the computing device may be ascertained and the opportunity for recovery enhanced.

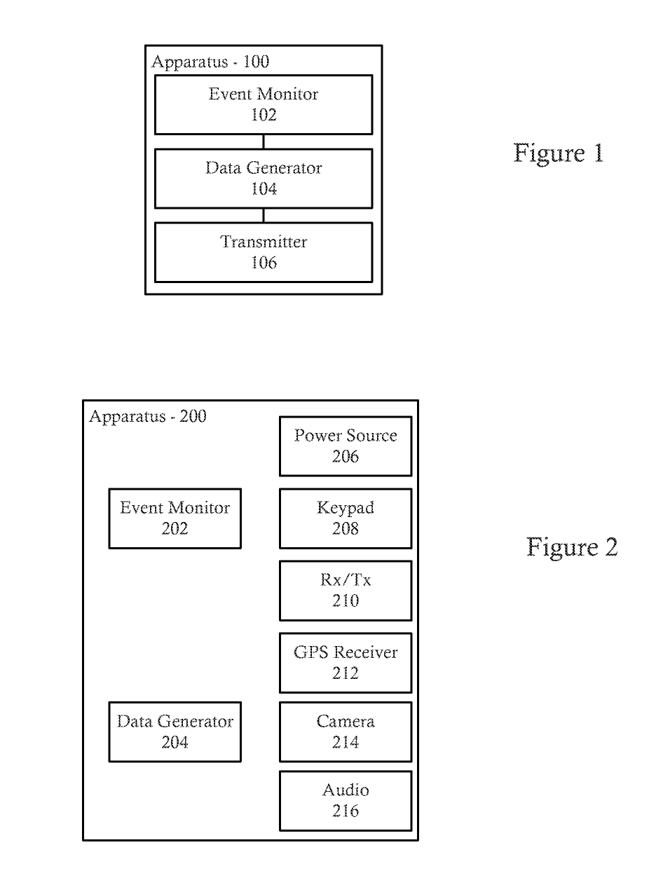

Referring to FIG. 1, an apparatus 100 is illustrated in accordance with an embodiment. The apparatus 100 includes an event monitor 102, a data generator 104, and a transmitter 106. In various embodiments, the apparatus 100 may be a wireless device such as but not limited, to a cellular device, a notebook computer, a netbook computer, a smart phone, or a tablet personal computer. Other apparatuses are contemplated.

The event monitor 102 is a component configured to monitor various events and generate a location discovery notification in response to a location discovery event. The event monitor 102 may be a hardware component such as an application specific integrated circuit (ASIC) or other integrated circuit. A location discovery event is an event which triggers the apparatus 100, via various components, to begin a location discovery procedure.

In one example, the event monitor 102 is configured to monitor a power capacity of the apparatus 100 and generate the location discovery notification in response to a determination that the power capacity is below a predetermined threshold. The apparatus 100 may utilize a portable power source, for example, a battery, to provide power. The event monitor 102 may be configured to monitor a capacity of the power source and when it falls below a predetermined threshold, generate the location discovery notification. In one example, the predefined threshold may be a percentage of remaining battery power, such as, ten percent. Other percentages are contemplated.

In another example, the event monitor 102 is configured to monitor a condition of a network and generate the location discovery notification in response to a determination that the condition of the network is degrading. For example, the apparatus 100 may be coupled to a network such as a wide area network (WAN), a wireless local area network (WLAN), or another network, and determine that a condition of the network is degrading. The degradation may be in due to environmental conditions, or the apparatus 100 moving farther away from the network access point. Because of the worsening network conditions, the event monitor 102 may generate the location discovery notification.

In another example, the event monitor 102 may be configured to monitor received commands and generate the location discovery notification in response to a determination that a received command is a wipe command. A wipe command may be a command that deletes, erases, or wipes information from the apparatus 100. A wipe command may be an indication that the apparatus 100 has been stolen. Based upon receipt of a wipe command, the event monitor 102 may generate the location discovery notification.

The event monitor 102 may be configured to monitor various events simultaneously, and generate a location discovery event in response to a receipt of a combination of events. For example, the event monitor 102 may be configured to generate a location discovery notification in response to a determination that a battery capacity has fallen below a predetermined threshold and that a network condition is degrading. In this manner, the apparatus 100 can send out a location discovery report prior to either the battery capacity expiring or a communication link with the network failing.

Data generator 104 is a component coupled to the event monitor 102. The data generator 104 is a component configured to generate geographic location data and contextual location data in response to receipt of a location discovery notification. The data generator 104 may be a hardware component such as an ASIC or other integrated circuit. The data generator 104 may utilize other components within the apparatus 100 to generate the geographic and contextual location data.

In one embodiment, the data generator 104 may be configured to generate geographic location data. Geographic location data is data that describes a location of the apparatus relative to the surface of the earth, for example, data that may be utilized to determine a location on a map. Examples of geographic location data include, but are not limited to, geographic coordinates received or generated based on signals from a geographic positioning satellite (GPS), data received from one or more WLANs in addition to various algorithms that may be utilized to determine a position based on a location of the WLAN. In various embodiments, the geographic location data may also include a list of the local area networks (LANs) viewable by the apparatus 100.

In the embodiment, the data generator 104 may also be configured to generate contextual location data. Contextual location data is data that describes a location of the apparatus based on its environment, for example, data that may enable a user to recognize a location, but otherwise does not include any geographic data. Examples of contextual location data include a picture of an environment in which the apparatus 100 is disposed, audio data recorded from the environment in which the apparatus 100 is disclosed. Contextual location data may enable an owner of the apparatus to recognize the location of the apparatus 100. For example, if an image of a light fixture is included in an image, an owner of the apparatus 100 may recognize the light fixture as being in their bedroom, and consequently, enable the user to locate the apparatus 100.

In addition to the event monitor 102 and the data generator 104, the apparatus 100 includes a transmitter 106. The transmitter 106 is coupled to the data generator 104 and is configured to transmit the geographic location data and the contextual location data to a network accessible server. The transmitter 106 may include or be coupled to other components including, but not limited to, a receiver and an antenna. The transmitter 106 may transmit the geographic and contextual location data to a server which may be accessed by a user. Storage of the geographic and contextual location data may enable a user to obtain the data at a later time despite a battery capacity of the apparatus 100 falling below an operable threshold, a failing network condition preventing communication with the apparatus 100, or an unauthorized user wiping the apparatus 100.

Referring to FIG. 2, another example of an apparatus 200 is illustrated in accordance with the present disclosure. The apparatus 200 includes an event monitor 202, a data generator 204, a power source 206, a keypad 208, a receiver/transmitter (Rx/Tx) 210, a GPS receiver 212, a camera 214, and an audio processor 216. Other components may also be included.

The event monitor 202, similar to the event monitor 102, may be a hardware component embodied in an ASIC or other integrated circuit. The event monitor 202 is configured to generate a location discovery notification in response to a location discovery event. The event monitor 202 is configured to monitor power source 206, keypad 208, and Rx/Tx 210.

The power source 206 is a direct current (DC) power source. In various examples, the power source 206 may be a battery such as a lithium battery, although other batteries and power sources are contemplated. The event monitor 202 may be configured to monitor remaining capacity of the power source 206. Various algorithms and hardware can be used to calculate a remaining capacity. Upon the power source 206 reaching a predetermined threshold, the event monitor 202 may generate a location discovery notification. The location discovery notification may be a flag or bit that triggers the data generator to generate the geographic and contextual location data. In various embodiments, the predefined threshold for the battery may be at a percentage, for example five percent of remaining power, but other thresholds are contemplated.

The Rx/Tx 210 may be one component, for example a transceiver, or may include a separate transmitter and a receiver. The Rx/Tx 210 may be configured to communicate with a network access point, which may be a base station or access point. The Tx/Rx 210 can be used to communicate over various protocols including cellular protocols and local area network protocols. In addition to communicating with various network access points, the Rx/Tx 210 may also receive signals that enable the apparatus 200 to determine a condition of the network, for example a received signal strength indication (RSSI). Other signals and manners of determining network conditions are contemplated. Based on the received signal, the event monitor 202 may be configured to determine whether the network condition is degrading, improving, or remaining stable. Based on an indication that the network condition is degrading, the event monitor 202 may generate the location discovery notification.

In addition to monitoring the power source 206 and the Rx/Tx 210 separately, the event monitor 202 may be configured to utilize both indicators concurrently. For example, the event monitor 202 may be further configured to determine whether the power source 206 is below a second predetermined threshold, for example twenty-five percent remaining capacity and generate the location discovery notification if the network condition is concurrently degrading. The event monitor 202 may look for the additional conditions of a battery capacity below a threshold in conjunction with degrading network conditions.

Keypad 208 may be a keyboard or keypad disposed on the apparatus 200 and configured to enable a user to interface with the apparatus 200. The keypad 208 may be a physical keyboard having discrete buttons or components representing various characters, or alternatively, may be a virtual keyboard displayed on a screen of the device. The event monitor 202 may be configured to monitor the keypad 208 for a string of characters indicating a wipe or reset command. In response to the wipe or reset command the event monitor 202 may generate the location discovery notification. In another example, the event monitor 202 may monitor a controller coupled to the keypad 202, wherein the controller is configured to receive and process any information received from keypad 202.

Based on receipt of the location discovery notification generated by event monitor 202, data generator 204 may generate geographic and contextual location data. The data generator 204, similar to data generator 104 of FIG. 1, may be a hardware component embodied in an ASIC or other integrated circuit. The data generator 204 may be coupled to the event monitor 202 and various other components that may be polled to generate the location data.

The data generator 204 may be used to generate geographic location data. To generate the geographic location data, the data generator may be coupled to the Rx/Tx 210 and GPS receiver 212. Rx/Tx 210 may be used to associate and communicate with various networks. Consequently, the Rx/Tx 210 may be used to generate a list of networks viewable by the apparatus 200. In one example, the Rx/Tx 210 may be capable of communicating with local area networks. Upon generating a list of the local area networks, a user may view the list and determine that one or more of the networks are associated with their home. Consequently, the user may determine that the apparatus 200 is at their home. Alternatively, the data generator 204 may use the Tx/Rx 210 and a network, to determine a geographic location. Various algorithms may be used and are contemplated and the results may be conveyed as a position on a map.

The GPS receiver 212 may be configured to receive signals from various geographic positioning satellites. In response to receipt of the location discovery notification, the data generator 204 may send and receive signals from the GPS receiver 212. The data generator 204 may receive signals that enable the apparatus 200 to determine a geographic coordinate of the device 200. The geographic coordinate may be conveyed as a coordinate and/or a position on a map.

The data generator 204 is also configured to generate contextual location data. The contextual location data may be generated by the camera 214 and the audio processor 216. The camera 214 may be a camera embodied within the housing of the apparatus 200. The camera 214 may be disposed on one side of the apparatus 200. Consequently, dependent upon what side of the apparatus is lying on, the camera may not be capable of producing a useful image. The data generator 204 may be configured to determine whether an image produced by the camera 214 is all black or all white, thereby indicating no useful information. Based on this determination the data generator may determine not to produce an image from camera 214 thereby saving power.

Audio processor 216 may be coupled to a microphone and a speaker. The audio processor 216 may be configured to produce contextual location data. In one example, the data generator 204 may turn on the microphone and record any audio data occurring in the environment of the apparatus 200. This audio data may enable a user of the device to recognize where the apparatus is currently located. Alternatively, the audio data may enable the user to determine whether an unauthorized user is currently in possession of the apparatus 200.

Based on the geographic and contextual location data generated by the data generator 204, the Tx/Rx 210 may transmit the data to a network accessible server. The data may be stored at the network accessible server so that a user may access the information. In this manner, data is protected from resets and failing power capacity. Additionally, the stored location data may be protected via a cryptographic key or password. This may prevent an unauthorized user from deleting the location data.

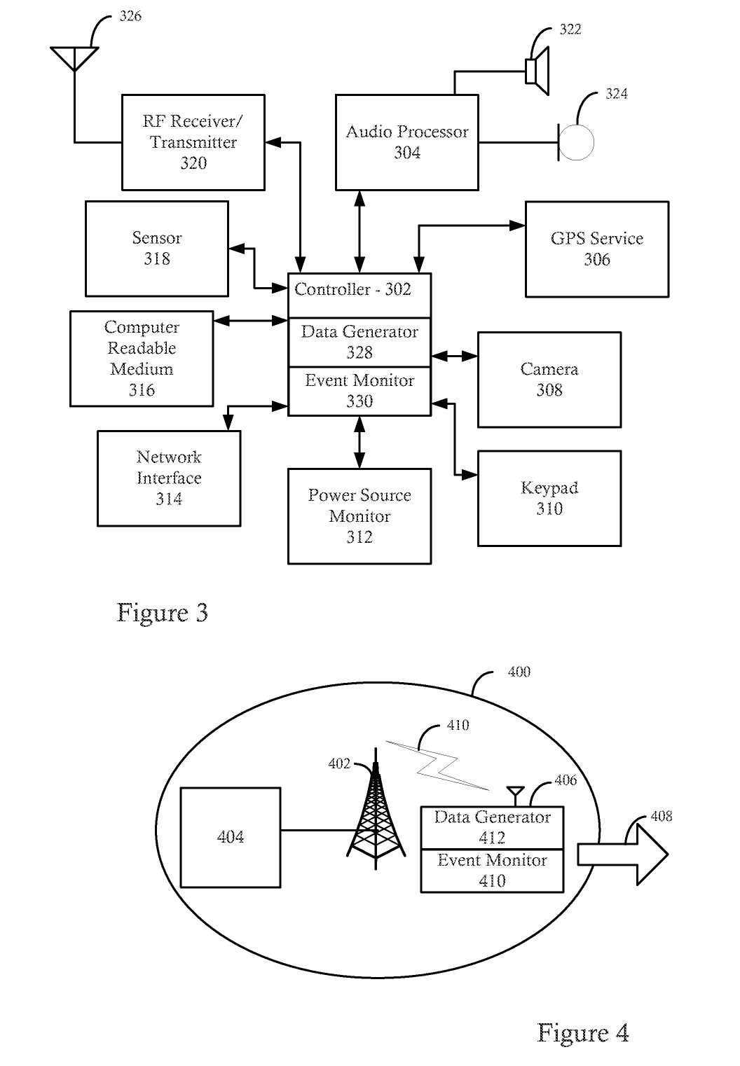

Referring to FIG. 3, an example system is illustrated in accordance with present disclosure. The system includes a controller 302 having a data generator 328 and a event monitor 330, an audio processor 304 coupled to a speaker 322 and a microphone 324, a GPS service 306, a camera 308, a keypad 310, a power source monitor 312, a network interface 314, a computer readable medium 316, a sensor 318, and an RF receiver/transmitter 320 coupled to an antenna 326. Other components may be included without deviating from the scope of the disclosure.

Computer readable medium 316 may be configured to store programming instructions, which when executed by a device, enable the device to perform various operations as described herein. In one embodiment, the computer readable medium 316 may be configured to store programming instructions that, when executed by the controller 302, enable the controller 302 to monitor various events via the event monitor 328 and generate geographic and contextual location data via the data generator 330.

In one embodiment, the controller 302 via programming instructions stored on the computer readable medium 316, may generate a location discovery notification in response to a location discovery event. The controller 302 may be coupled to and monitor the power source monitor 312. The power source monitor 312 may be configured to generate power level indication signals. When a power source falls below a predetermined threshold, the power source monitor 312 may indicate an event to the controller 302, and the controller 302 may generate a location discovery notification.

In the illustrated embodiment, the controller 302 is coupled to the network interface 314 and the RF Receiver/Transmitter 320. The controller 302 may be configured to monitor connections with various networks via the network interface 314 and the RF Receiver/Transmitter 320. In response to degradation of a network coupled to either the network interface 314 and/or the RF Receiver/Transmitter 320, the controller 302 may generate a location discovery notification.

Controller 302 is illustrated as being coupled to keypad 310. Controller 302 may be configured to receive various commands from keypad 310. Keypad 310 may be utilized to enter characters, commands, symbols, or to otherwise interact with the system. In response to the keypad 310 receiving a command to reset or wipe data within the system, the controller 302 may generate a location discovery notification.

In response to the location discovery notification, the controller 302 may utilize the camera 308, the network interface 314, the RF Receiver/Transmitter 320, GPS service 306, and audio processor 304 to generate location data. For example, the controller 302 may utilize the network interface 314 to generate a list of wireless networks or to calculate an approximate location of the system. Additionally, the controller 302 may utilize the GPS service to generate geographic coordinates of a location of the system. The controller 302 may also utilize the camera 308 and the audio processor 304 to generate contextual location data.

Based on the location data, both geographic and contextual, the RF Receiver/Transmitter 320 may transmit the location data to a network accessible server or other device. The data may then be accessed by an owner of the system to determine its location. In various embodiments, the system may be moved after generating the geographic and contextual location data. Consequently, the system may need to update the location data. In various embodiments, the location data may be updated at regular intervals. Alternatively, the controller 302 may monitor sensor 318 to determine whether the system has moved.

Sensor 318 may be an accelerometer configured to detect movement. In response to detected movement by the sensor 318, the system may update geographic location data and/or contextual location data. In another embodiment, sensor 318 may detect no movement of the system. In response to detecting no movement, the system may reduce power to various components to conserve power. The system may periodically return power to the components to update the location data. This may prolong the capacity of the power source. Other manners of determining whether an update is needed are contemplated.

FIG. 4 illustrates a diagram of a system in accordance with various embodiments. The system includes a network access point 402 that provides for communication within area 400. The network access point may be coupled to a network accessible server 404 via various other networks. The network access point 402 may communicate with wireless device 406 via link 410. In the illustrated embodiment, the wireless device 406 may be moving out of the network area 400 as indicated by arrow 408.

In the illustrated example, wireless device 406 may be a device as described with reference to FIGS. 1-3. The device 406, via an event monitor 410, may determine whether a location discovery event has occurred. In the illustration, the event monitor 410 may determine that the condition of network 400 is degrading. The degradation may be due to the wireless device 406 leaving network 400. In response, the event monitor 410 may generate a location discovery notification.

Based on the location discovery notification, the wireless device 406, via a data generator 412, may generate geographic location data and contextual location data. The wireless device 406 may then transmit this location data to the network access point 402 and ultimately to a network accessible server 404. The network accessible server 404 may store the location data, both geographic and contextual, and enable a user or owner of wireless device 406 to determine a location of the wireless device 406.

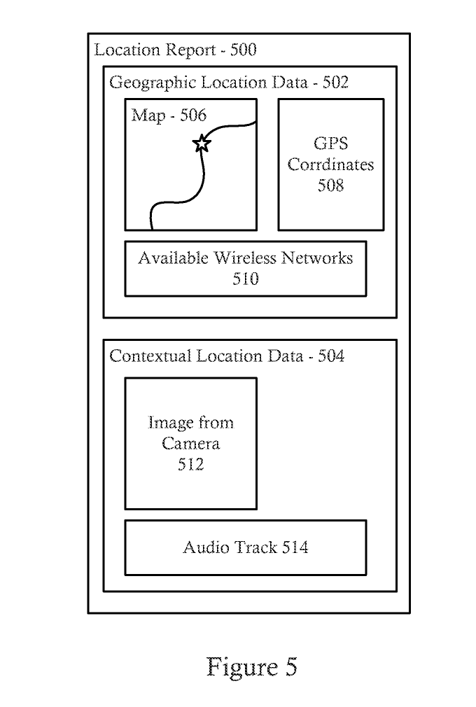

In various embodiments, the wireless device 406 may transmit the geographic location data and the contextual location data in a location report. Referring now to FIG. 5, an example location report 500 is illustrated. The location report 500 includes geographic location data 502 and contextual location data 504.

Geographic location data 502 may include a map 506, GPS coordinates 508, and a list of available wireless networks 510. The map 506 may be based on information obtained from the GPS coordinates 508 or the available wireless networks list 510. In various embodiments, various ones of the geographic location data 502 may not be available. Consequently, geographic location data 502 may include any combination of the map 506, GPS coordinates 508, and available wireless networks 510.

Contextual location data 504, in the illustrated example, includes an image 512 and an audio track 514. In various embodiments the wireless device may be configured to determine whether contextual location data 504 is available and useful prior to its inclusion in the location report 500. For example, the wireless device may determine that the image 512 is completely black indicating that the camera is lying on its lens or that the lens is otherwise obscured. In response, the wireless device may refrain from including the image in the location report 500. Alternatively, if the wireless device determines that no sound is in the environment, or alternatively, that the audio data is merely noise, it may abstain from including audio track 514 within the contextual location data 504.

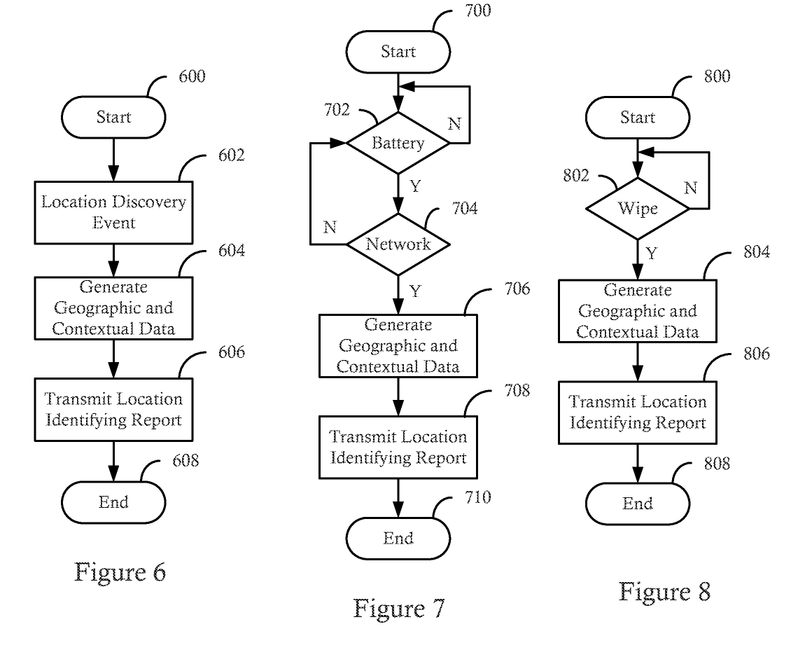

Referring to FIGS. 6-9, flow diagrams are illustrated in accordance with various embodiments. The flow diagrams may illustrate methods or operations performed by any of the apparatuses or systems described in FIGS. 1-3.

Referring to FIG. 6, the method may begin at 600 and progress to 602 where the device may monitor and determine whether a location discovery event has occurred. In response to the location discovery event, the apparatus may generate geographic location data and contextual location data at 604. The geographic location data and the contextual location data may be included in a location identifying report. With the location data generated, a wireless device may transmit the location identifying report to a computing device at 606, The computing device may be a network accessible server and may be accessed by an owner of the wireless device to facilitate a location determination and recovery of the wireless device. The method may then end at 608. In various embodiments, ending may include repeating the above methodology.

Referring now to FIG. 7, the method may begin at 700 and progress to 702 where a determination of whether the battery capacity is below a predetermined threshold is made. If the battery capacity is not below the predetermined threshold, the method may continue to monitor the battery capacity at 702. If the battery capacity is below the predetermined threshold, the wireless device may determine whether a network condition is also degrading at 704. If the network condition is not degrading, the wireless device may continue to monitor a capacity of the battery until, for example, the battery reaches another predetermined threshold (not illustrated). The other predetermined threshold may indicate a more imminent battery failure.

If the network condition is degrading at 704, the wireless device may generate the geographic location data and the contextual data at 706. Generating the geographic location data may entail utilizing a GPS service, a network interface, or a Rx/Tx as previously described. Generating the contextual location data may entail utilizing a camera and an audio processor coupled to a speaker and a microphone as previously described.

At 708, the wireless device may transmit a location identifying report that includes the geographic location data and the contextual location data to a computing device. The computing device may be a network accessible server configured to store the location data. The method may end at 710. In various embodiments, ending may include repeating the above methodology.

Referring to FIG. 8, the method may begin at 800 and progress to 802 where the wireless device may monitor for a wipe event or a reset event. A wipe event may be a command that deletes data from a memory. The amount of memory that may be deleted without triggering the location discovery event may be predetermined or set by a user. If no wipe event has occurred, the method may continue to monitor for an wipe event at 802.

If a wipe event has occurred, the method may progress to 804 where the wireless device may generate the geographic location data and the contextual location data. Generating the geographic location data may entail utilizing a GPS service, a network interface, or an Rx/Tx as previously described. Generating the contextual location data may entail utilizing a camera and an audio processor coupled to a speaker and a microphone as previously described,

At 806, the wireless device may transmit a location identifying report that includes the geographic location data and the contextual location data to a computing device. The computing device may be a network accessible server configured to store the location data. The method may end at 808. In various embodiments, ending may include repeating the above methodology.

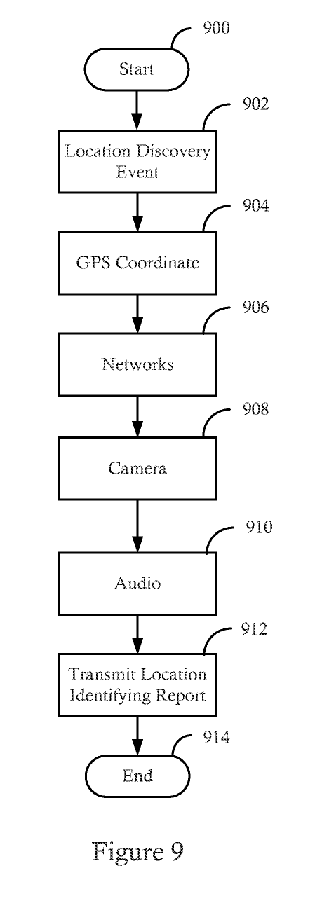

Referring to FIG. 9, the method may begin at 900 and progress to 902 where the wireless device may monitor or determine whether a location discovery event has occurred. A location discovery event may include the battery capacity falling below a predetermined threshold, a degrading network condition, a wipe or reset command, or a combination of events.

In response to a location discovery event, the wireless device may attempt to determine its location via GPS at 904. The wireless device may transmit and/or receive signals from geographic positioning satellites and utilize the received signals to determine a location of the wireless device. At 906, the wireless device may aggregate a list of local area networks viewable by the wireless device. These networks may enable a user to determine an approximate location. Additionally, the networks may be used, along with an algorithm, to determine an approximate location of the wireless device with the result conveyed as a position on a map.

At 908, the wireless device may generate contextual location data with a camera. The image received from the camera may be examined. In response to the image including useful information, which may be determined by the image including distinguishable objects, the image may be included in the location identifying report. At 910, an audio processor may be used to determine whether any useful information may be garnered from the environment. In response to a determination that audio information is available, the audio information may be included in the location identifying report.

At 912, the wireless device may aggregate the geographic location data and the contextual location data into the location identifying report and transmit the location identifying report to a computing device The method may end at 914. In various embodiments, ending may include repeating the above methodology.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope of this disclosure. Those with skill in the art will readily appreciate that embodiments may be implemented in a wide variety of ways. This application is intended to cover any adaptations or variations of the embodiments discussed herein. Therefore, it is manifestly intended that embodiments be limited only by the dams and the equivalents thereof.

1. An apparatus, comprising:
an event monitor to generate a location discovery notification in response to a location discovery event;
a data generator coupled to the event monitor, to generate geographic location data and contextual location data in response to the location discovery notification, wherein the contextual location data is generated based on a determination that a lens of the apparatus is not obscured and audio data received by the apparatus includes sound; and
a transmitter coupled to the data generator, wherein the transmitter is to transmit the geographic location data and the contextual location data to a network accessible server.

2. The apparatus of claim 1, wherein the event monitor is to monitor a power capacity of the apparatus and generate the location discovery notification in response to a determination that the power capacity is below a predetermined threshold.

3. The apparatus of claim 2, wherein the event monitor is further to monitor a condition of a network and generate the location discovery notification in response to a determination that the condition of the network is degrading and the power capacity is below a second predetermined threshold that is different than the predetermined threshold.

4. The apparatus of claim 1, wherein the event monitor is to monitor a received command and generate the location discovery notification in response to a determination that the received command is a wipe command.

5. The apparatus of claim 1, wherein the geographic location data comprises a geographic coordinate generated by a geographic positioning satellite (GPS) service.

6. The apparatus of claim 1, wherein the geographic location data comprises a list of wireless local area networks (WLANs) viewable by the apparatus.

7. The apparatus of claim 1, wherein the contextual location data comprises an image of an environment of the apparatus and audio data associated with the environment.

8. A method, comprising:
determining, by a wireless device, that a location discovery event has occurred;
determining, by the wireless device, that a received image and received audio data include a distinguishable object;
generating, by the wireless device, geographic location data and contextual location data in response to the location discovery event and the determination of the distinguishable object; and
transmitting, by the wireless device, a location identifying report to a computing device, wherein the location identifying report includes the geographic location data and the contextual location data.

9. The method of claim 8, wherein determining that the location discovery event has occurred comprises determining that a battery capacity of the wireless device is below a predetermined threshold.

10. The method of claim 9, wherein determining that the location discovery event has occurred further comprises determining that a network condition is degrading.

11. The method of claim 8, wherein determining that the location discovery event has occurred comprises receiving a command to reset the wireless device.

12. The method of claim 8, wherein generating the geographic location data comprises determining a geographic coordinate of the wireless device based on a geographic positioning satellite (GPS) service.

13. The method of claim 8, wherein generating the geographic location data comprises generating a list of networks viewable by the wireless device.

14. The method of claim 8, wherein generating the contextual location data comprises activating a camera integrated with the wireless device to produce an image of an environment.

15. The method of claim 8, wherein generating the contextual location data comprises activating a microphone and a recorder to produce audio data of an environment.

16. The method of claim 8, further comprising:
determining, by the wireless device, that a location of the wireless device has changed; and
repeating the generating and the transmitting in response to the determination that the location has changed.

17. A non-transitory computer readable medium having a plurality of instructions stored thereon, wherein the plurality of instructions, if executed, cause a computing device to:
monitor for a location discovery event;
generate geographic location data and contextual location data in response to the location discovery event, wherein the contextual location data is generated if a lens of the apparatus is not obscured or audio data received by the apparatus includes sound; and
transmit a location identifying report to a server communicatively coupled to the computing device, wherein the location identifying report includes the geographic location data and the contextual location data.

18. The article of manufacture of claim 17, wherein the geographic location data includes a geographic coordinate of the computing device.

19. The article of manufacture of claim 17, wherein the contextual location data includes an image generated by the computing device.

20. The article of manufacture of claim 17, wherein the location discovery event consists of at least one of a power capacity below a predetermined threshold, degradation of a network condition, and a wipe command received by the computing device.
